(19) United States
(12) Patent Application Publication
(10) Pub. No.: US 2006/0026936 A1
(43) Pub. Date: Feb. 9, 2006

(54) Air ventilation module for a vehicle cabin

(75) Inventors: Carine Paumier, Versailles (FR); Gilles Elliot, Courcouronnes (FR); Alain Renard, Gambaiseuil (FR); Vincent Feuillard, Le Mesnil Saint Denis (FR); Bertrand Puzenat, Montigny Le Bretonneux (FR); Laurent Tellier, Paris (FR)

Correspondence Address: Valeo Climate Control Corp.;Intellectual Property Department, 4100 North Atlantic Boulevard, Auburn Hills, MI, 48326, US

(73) Assignee: Valeo Climatisation S.A., La Verriere (FR)

(21) Appl. No.: 11/194,199

(22) Filed: Aug. 1, 2005

(30) Foreign Application Priority Data
Aug. 4, 2004 (FR) 04 08590

(51) Int. Cl. B60H 3/06; B01D 45/00

(52) U.S. Cl. 55/473; 454/140; 454/158; 454/230

(57) ABSTRACT

The invention concerns an air ventilation module for a cabin, in particular for an automobile. The module comprises a housing able to be installed in a chosen location in the cabin, the housing having an air inlet and at least one air outlet and accommodating an air propulsion member comprising at least one motor and a rotary element for moving the air, which is accommodated in an internal chamber of the housing. The module can also comprise a filter for also providing a filtration function. Application in particular to automobile equipment.

### FIELD OF THE INVENTION

The invention concerns a ventilation module, in particular for a vehicle cabin, especially for an automobile.

### BACKGROUND OF THE INVENTION

It concerns more particularly a module comprising a housing able to be installed in a chosen location in the cabin, the housing having at least one air inlet and at least one air outlet and accommodating an air propulsion member comprising at least one motor and a rotary element for moving the air.

Modules of this type are already known that are designed for being placed in a cabin, in particular in an automobile, constituting an independent unit able to provide air ventilation locally in the cabin.

Such a module can be installed for example below the roof of an automobile in order to provide air ventilation in addition to the heating, ventilation and/or air conditioning installation that the vehicle comprises.

This may have an advantage in providing an additional comfort function, for example at the rear of the cabin of a large vehicle.

The module may possibly fulfill other functions, in particular a function of filtration of the air that is discharged through the air outlet or outlets of the module.

In all cases, an air ventilation module of this type constitutes an independent element that is added to the heating, ventilation and/or air conditioning installation of the vehicle, without however replacing it.

The air ventilation modules used up to the present time are rudimentary in design and usually comprise a housing accommodating an air propulsion member of the fan type and possibly a rudimentary filter, so that they principally provide ventilation of the air to be sent into the cabin.

The invention aims to improve the situation.

Consequently one of the aims of the invention is to propose a module of the aforementioned type that provides correct ventilation of the air under conditions as efficient as possible.

Another aim of the invention is to propose such a module that also provides filtration of the air, and in particular eliminates odors contained in the air in the cabin.

Another aim of the invention is to propose such a module that can provide ventilation and/or filtration functions whilst generating a minimum pressure drop.

Another aim of the invention is to propose such a module that can be designed according to different variants and in particular with different types of air propulsion members and filters, where applicable.

Another aim of the invention is to propose such a module that is of compact design and that can be located easily at a chosen point in the cabin.

### SUMMARY OF THE INVENTION

The invention proposes for this purpose an air ventilation module, in particular for a vehicle cabin, of the type defined above, in which the rotary element of the air propulsion member is accommodated in an internal chamber of the housing.

In a preferred embodiment of the invention, the module also comprises a filter, which filters the air in the cabin, in order to eliminate odors therefrom.

Advantageously in this case the air propulsion member is placed upstream with respect to the filter, so that the internal chamber delimits an expansion volume for the compressed air issuing from the air propulsion member.

When a filter is present, the internal chamber is also advantageously delimited at the outlet by this filter.

In a variant embodiment, the air propulsion member is placed downstream with respect to the filter, so that the internal chamber delimits a volume for the filtered air.

Various types of air propulsion member, also referred to as “air fans”, can be used in the context of the invention, in particular of the radial, tangential or axial type.

It is in particular preferred to use an air propulsion member of the radial type, that is to say the rotary element of this member is a radial turbine accommodated in the housing.

When a filter is present and the fan is placed upstream of the filter, the aforementioned internal chamber is delimited directly around the turbine, which reduces the size and the pressure drops.

Since it is a case of a radial turbine, advantageously a turbine provided with blades is used, the filter then being spaced apart from the turbine.

In another embodiment of the invention, the rotary element of the air propulsion member is a tangential turbine.

The internal chamber can delimit a fixed volume. It can also, in a variant, delimit a variable volume created by the mobility of at least one internal member of the module.

This internal member advantageously consists of a filter when the module is equipped with one.

It is then preferred for the filter to be mounted so as to be able to move in the housing between a “retracted” position where the internal volume of the internal chamber is reduced and an “emerged” position where the volume of the internal chamber is increased. It can be envisaged, for this, that the filter be mounted so as to pivot with respect to the housing or, in a variant, for it to be mounted so as to be able to move in translation with respect to the housing.

In another embodiment, the filter is fixed to a cover mounted so as be able to move with respect to the housing. This means consequently that this cover can for example be mounted so as to pivot or be mounted so as to be able to move in translation with respect to the housing.

The cover can also serve to support members other than the filter, for example the air propulsion member.

In this case, being able to move the cover makes it possible to access not only the filter but also the air propulsion member, in particular for maintenance purposes.

In an advantageous embodiment, the module comprises at least one filtered air outlet for air issuing from the filter and at least one ventilated air outlet for non-filtered air, and switching means for making the air pass selectively through the filtered air outlet an/or the non-filtered air outlet. It will be understood that, when the air passes directly to the non-filtered air outlet, without having previously been filtered, this makes it possible to increase the ventilation rate by reducing the pressure drops.

Various solutions can be envisaged for providing this switching function.

In a first variant, the housing comprises a body provided with an open face and a cover mounted so as to pivot with respect to the body between a position “retracted” in the housing and in a position “emerged” from the housing, the cover comprising at least one filtered air outlet provided in a main face and at least one non-filtered air outlet provided in the lateral face, the non-filtered air outlet being left clear by the housing body when the cover is in the emerged position and closed off by the housing body when the cover is in the retracted position.

In a second variant, the housing comprises a main face in which at least one air outlet is provided for filtered and/or non-filtered air, the filter being mounted so as to slide opposite the air outlet between a position in which the filter leaves clear the air outlet in order to make non-filtered air pass and another position in which the filter closes off the outlet in order to make filtered air pass.

It may be advantageous to provide at least one electrical element, in particular an element with a positive temperature coefficient, to heat the air sent into the cabin.

The filter used, if present, is capable of various variants. It may be a case for example of a particle filter, an activated carbon filter or a photocatalytic filter.

In the following description, given solely by way of example, reference is made to the accompanying drawings, in which:

### BRIEF DESCRIPTION OF THE DRAWINGS

FIG. 1 is a partial perspective view of an air ventilation module according to a first embodiment of the invention, in which part of the housing is removed;

FIG. 2 is a view in vertical section of the module of FIG. 1;

FIG. 3 is a perspective view of the module of FIGS. 1 and 2, the top of the housing being removed;

FIG. 4 is a perspective view of an air ventilation module according to a second embodiment of the invention, the module comprising a pivoting cover shown in the “emerged” position for ventilation;

FIG. 5 is a view similar to FIG. 4 showing the same module in which the cover is in the retracted position in order to fulfill an air filtration function;

FIGS. 6 to 8 are perspective views, with the housing removed, of an air ventilation module according to a third embodiment of the invention in which the filter is mounted so as to slide in order to selectively provide a filtration or ventilation function;

FIG. 9 is a perspective view, with partial cutaway of the housing, of an air ventilation module similar to that of FIGS. 6 to 8 but also comprising a heating element;

FIGS. 10 to 13 are schematic side views of four air ventilation modules whose internal chambers delimit a fixed volume;

FIGS. 14 to 17 are schematic views of four air ventilation modules whose filters are mounted so as to pivot in order to provide internal chambers of variable volume;

FIGS. 18 to 21 are schematic views similar respectively to FIGS. 14 to 17, in which each module also comprises a pivoting cover;

FIGS. 22 to 25 are schematic views of four air ventilation modules comprising a filter mounted so as to slide vertically in order to delimit an internal chamber of variable volume; and

FIGS. 26 to 29 are views similar to FIGS. 22 to 25, in which the module also comprises a movable cover.

### DESCRIPTION OF THE PREFERRED EMBODIMENTS

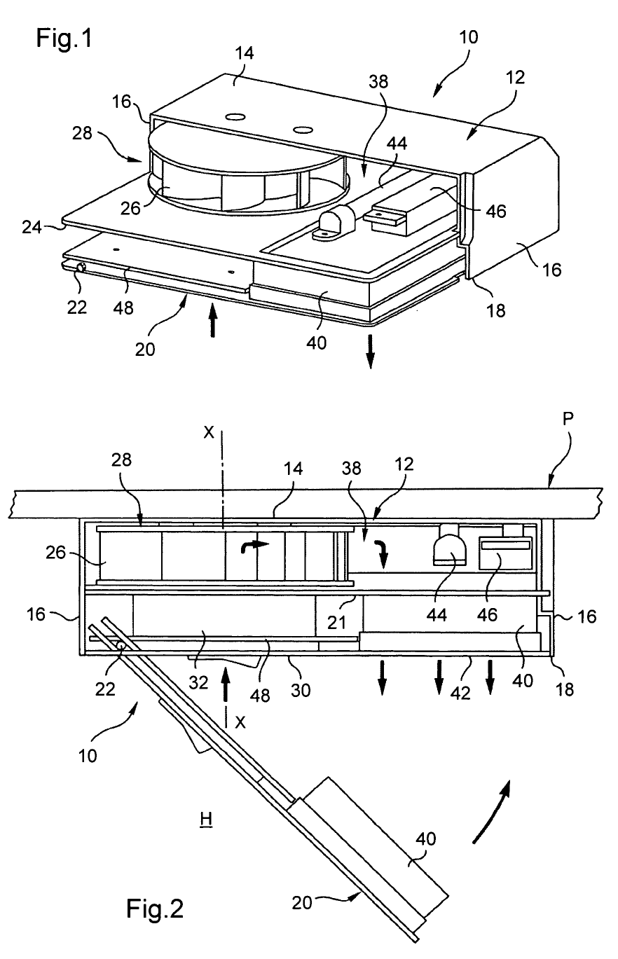

Reference is made first of all to FIG. 1, which shows an air ventilation module, designated overall by the reference 10, designed to be located at a chosen position inside an automobile cabin. In the example this module also fulfils a filtration function and therefore constitutes a ventilation and/or air filtration module.

The module 10 comprises a housing 12, parallelepipedal in shape overall, having a top wall 14 designed to be placed, in the example, in a substantially horizontal position, in particular under the roof P (FIG. 2) of a vehicle, being thus disposed in the cabin H of this vehicle.

The housing 14 also comprises lateral walls 16 that delimit an open face 18, rectangular in shape overall, which is here turned downwards. The open face 18 is closed off by a cover 20 which, in the example, is a movable cover, here a cover mounted so as to pivot about a spindle 22 (FIG. 2). A partition 24 is placed inside the housing in a position roughly parallel to the top wall 14. In the space delimited by the partition 24 and the top wall 14 there is disposed a rotary element 26 of an air propulsion member 28, which will be referred to as an “air fan” in the remainder of the description.

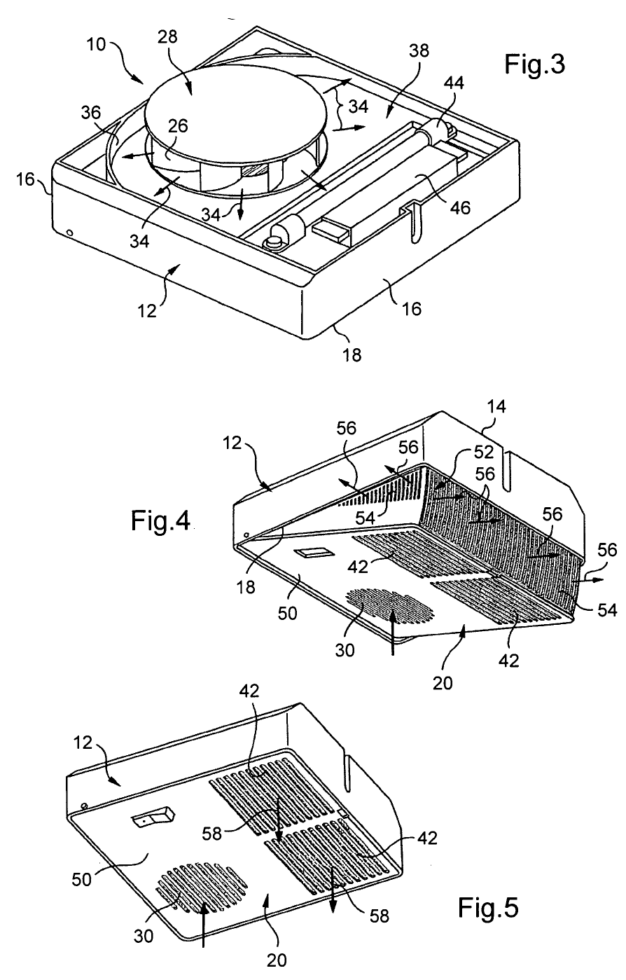

The rotary element 26 is produced here in the form of a radial turbine provided with blades (FIGS. 1 to 3) and driven in rotation about an axis X-X (FIG. 2) perpendicular to the top wall 14. The air fan 28 comprises an electric motor (not shown) that rotationally drives the turbine 26, thus sucking an air flow coming from the cabin, this air flow passing through an air inlet 30 (FIG. 2) provided in the cover 20. The air then accesses the aforementioned internal space through a suction tube 32. The air flow thus sucked is accelerated by the radial turbine 26 in the direction of the arrows 34 shown in FIG. 3.

In the aforementioned internal space a curved-shaped partition 36 is disposed that delimits an internal air chamber 38 in which the radial turbine 26 is housed. The air then leaves the internal chamber 38, passing through a filter 40 which is disposed on the cover 20 and thus delimits the internal outlet chamber 38. When the cover 30 is in the closed position, depicted in the top part of FIG. 2, the filter is situated in the housing and can thus provide the filtration of the air that leaves the housing through an air outlet 42 (FIG. 2). When the cover is in the open position, as shown in the bottom part of FIG. 2, the filter 40 is accessible and can be exchanged if necessary. In the example embodiment, the filter is of the photocatalysis type. It is associated with a UV lamp 44 and a ballast 46 in a manner known per se.

According to the present example embodiment, all the components are arranged in the housing 14. However, certain components may interfere with the air flow and impair the ventilation/acoustic performance of the module 10. According to a variant embodiment, provision is made to produce a so-called “technical” area in which the components will be disposed, such as the electronic cards, giving rise to a degradation of ventilation/acoustic performance.

This so-called “technical” area is disposed around a so-called “functional” area. The so-called “functional” area integrates all the elements of the module 10 such as the fan motor, the filter etc.

As can also be seen in FIG. 1, an electronic card 48 is placed on the cover 20. Access to this card is facilitated by the opening of the cover. With this card there are associated control means, for example a control button, which are not visible in FIGS. 1 to 3. These control means are accessible from the outside of the cover and enable a user to actuate, when he so desires, the air fan 28.

In a similar fashion, the electronic card 48 comprises an air quality sensor integrated directly on the electronic card 48. Such an arrangement affords an improvement in internal comfort by taking into consideration the state of the environment of the device according to the present invention. Thus disposed, the air quality sensor is exposed in a satisfactory fashion to the air flow entering the housing 14.

Nevertheless, an alternative embodiment consists of locating the air quality sensor on a wall of the housing 14.

The aforementioned internal chamber 38 delimits an expansion volume in which the compressed air issuing from the air propulsion member can expand, on the sides of the turbine, before being filtered, which improves the functioning of the module by reducing the pressure drops.

According to a preferential embodiment, the expansion volume has a length along the air flow of between 0 mm and 10 mm. Such an arrangement makes it possible to provide a reduction in the dimensions in line with the air flow.

However, in the device in FIGS. 1 to 3, the filtration takes place continuously, that is to say it is not possible to effect solely ventilation without filtration.

The device depicted in FIGS. 4 and 5 makes it possible to fulfill such a function by virtue of switching means.

The housing 12 comprises an open face 18 and a cover 20 mounted so as to pivot with respect to the body between a position retracted in the housing (FIG. 5) and a position emerged from the housing (FIG. 4). The cover comprises an air inlet 30 and two air outlets 42 provided in a main face 50. The air outlets 42 are intended to make an air flow, previously filtered, pass to the cabin H of the vehicle. The cover comprises at least one lateral face 52 in which at least one air outlet 54 is provided for non-filtered air (FIG. 4).

In the position of FIG. 4, the non-filtered air outlets 54 are left clear so that air can escape into the cabin, without being filtered, as shown by the arrows 56. On the other hand, when the cover is in the retracted position of FIG. 5, the air outlets 54 are closed off and the air is obliged to pass solely through the air outlets 42 in order to admit filtered air into the cabin. Thus, by modifying the position of the cover 20, it is possible to admit into the cabin either ventilated air, therefore with a higher flow rate, or filtered air, therefore with a lower flow rate because of the pressure drops caused by the filter. In certain circumstances, it is advantageous to favor ventilation rather than filtration. In the case in FIG. 5, the filtered air escapes to the cabin through the outlets 42 as shown by the arrows 58.

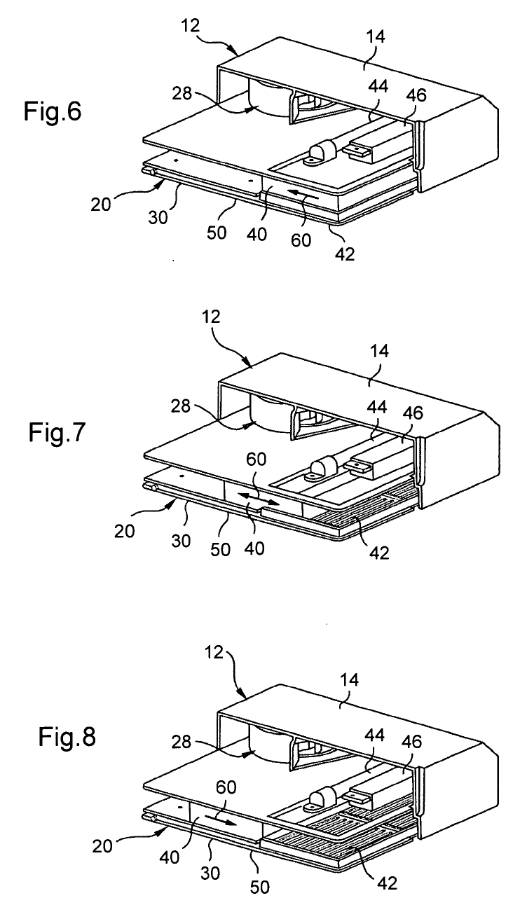

Reference is now made to FIGS. 6 to 8 which show another embodiment of the invention similar to that in FIGS. 1 and 2.

As in the case in FIGS. 4 and 5, switching means are provided to selectively provide ventilation or filtration. Here the housing comprises a cover 20 with a main face 50 in which there are provided an air inlet 30 (not visible in FIGS. 6 to 8) and an air outlet 42 which is visible solely in FIGS. 7 and 8.

Preferentially, the air inlet 30 and the air outlets 42 comprise elements orienting the incoming and outgoing air flows of the module 10. These elements can in particular be vanes or deflectors. In order to facilitate the circulation of the air flows, the orientation of the elements orienting the air flow entering through the air inlet 30 is opposite to the orientation of the air flow emerging through the air outlets 42. Thus the air flows enter and leave the module 10 in different directions.

Such an arrangement reduces the recirculation effect (reintroducing the air flow directly issuing from the air outlets 42) whilst providing an orientation of the air flow emerging in a required direction.

The filter 40 is mounted so as to slide in the direction of the arrow 60 parallel to the cover 50. The sliding of the filter takes place opposite the air outlet 42 between a position in which the filter closes off the air outlet (FIG. 6) in order to make filtered air pass and a position in which the filter leaves clear the air outlet in order to make non-filtered air pass (FIG. 8).

The figure can adopt intermediate positions as shown in FIG. 7 in which part of the air flow is filtered and another part of the air flow is not filtered.

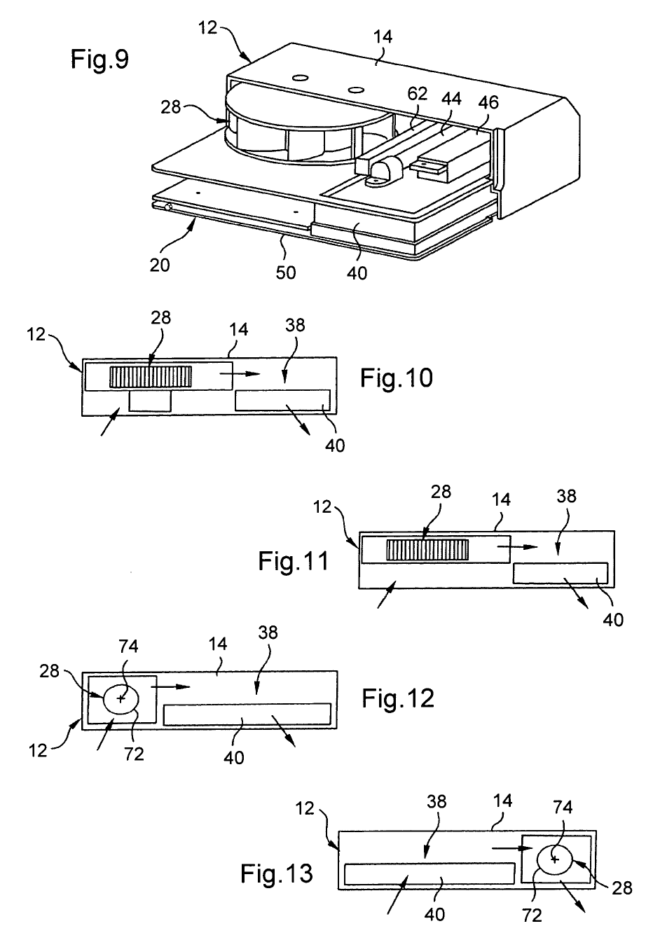

Reference is now made to FIG. 9, which depicts another embodiment of the invention that is similar to that in FIGS. 1 to 3. Here the housing accommodates in addition an electrical element 62, in particular an element of the type with positive temperature coefficient (abbreviated to PTC element). Such an element, if requires, provides heating of the air issuing from the fan 28, before passing through the filter 40. It is necessary however to ensure that the heating of the air does not interfere with the filter. This is because certain types of filter do not function optimally with heated air.

Reference is now made to FIGS. 10 to 13 which show respectively four modules which all have in common the fact that they delimit an internal chamber 38 of fixed, that is to say constant, volume. In the case of FIGS. 10 to 12 the fan 28 is placed upstream with respect to the filter 40 whilst in the case in FIG. 13 the fan is placed downstream with respect to the filter. In all cases, the chamber 38 is placed between the fan 28 and the filter 40. In the case in FIG. 10, the fan is of the centrifugal/radial type with a brush-type electric motor, whilst in the case in FIG. 11 the fan is of the centrifugal/radial type with an electric motor without brushes, also referred to as “brushless” (the English term). In the case in FIGS. 12 and 13, the fan is of the transverse/tangential flow type. It comprises a turbine 72 of elongate shape rotating about a spindle 74 that in the example is parallel to the top wall 14 of the housing.

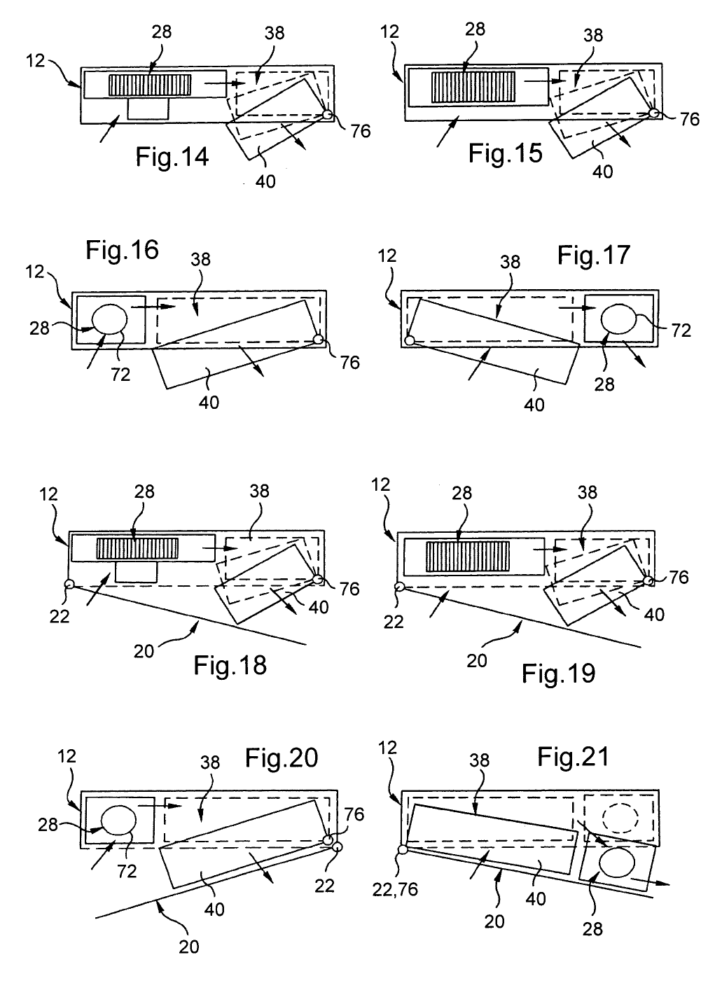

FIGS. 14 to 17 depict fans similar respectively to those in FIGS. 10 to 13. The main difference lies here in the fact that the filter 40 is mounted so as to pivot about an axis 76 between a retracted position in which the air volume of the chamber 38 is reduced and an emerged position in which the volume of air in the chamber 38 is increased. In the retracted position in which the filter is shown in dotted lines, the appliance can function with a reduced space requirement because the filter is retracted in the housing. In the emerged position in which the filter is shown in solid lines, the volume of the chamber is increased and the filter can function effectively.

Reference is now made to FIGS. 18 to 21, which are similar respectively to FIGS. 14 to 17. Here the housing also comprises a pivoting cover 20 similar to the one described previously. In the case of FIGS. 18 and 19, the cover 20 pivots about a spindle 22 parallel to the pivot spindle 76 of the filter. The cover must be opened partially to allow the pivoting of the filter towards its emerged position of use.

In the case of FIG. 20, the spindle 22 of the cover is situated in the immediate vicinity of the pivot spindle 76 of the filter so that the filter and cover can pivot almost in synchronism. In the case of FIG. 21, the cover 20 supports both the filter 40 and the fan 28 (here a centrifugal fan) so that the spindles 22 and 26 are merged.

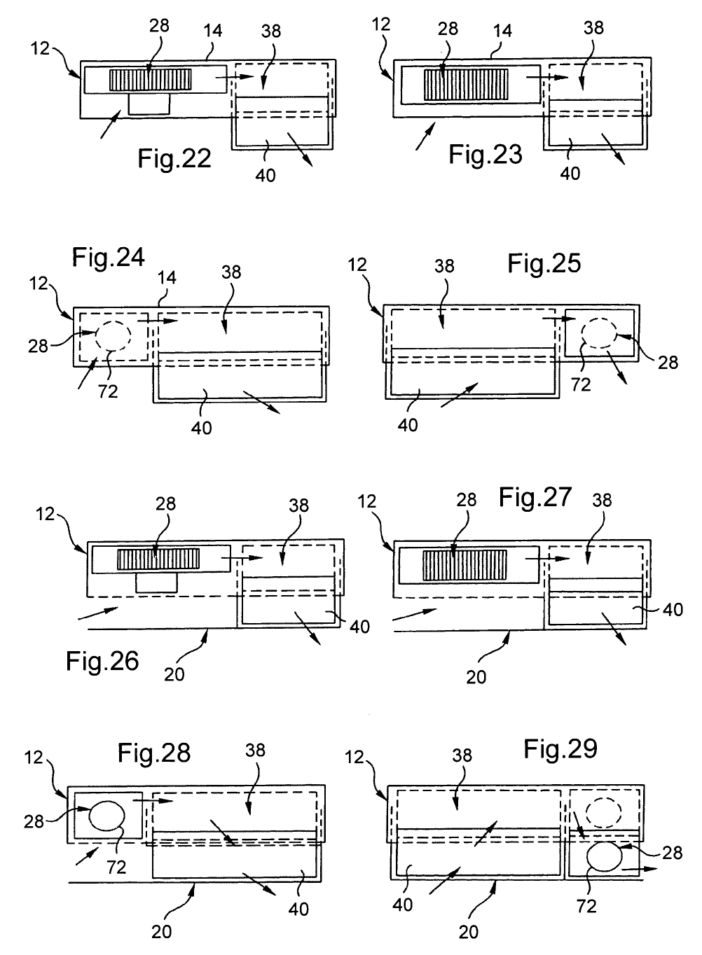

FIGS. 22 to 25 show four embodiments of a fan which are similar respectively to FIGS. 10 to 13. Here the filter 40 is mounted for translation in a direction roughly perpendicular to the top wall 14 of the housing. This makes it possible to delimit also a chamber 38 of variable volume between the fan and the filter. The filter can be moved between a retracted position depicted in dotted lines and an emerged position depicted in solid lines.

Reference is now made to FIGS. 26 to 29, which are similar respectively to FIGS. 22 to 25. It can be seen that, in each case, the housing 12 comprises a cover 20 that supports the filter 40. This cover 20 is here able to move in translation in a direction roughly perpendicular to the top wall 14 of the housing. This cover can be moved from an emerged position (shown in solid lines) to a retracted position (shown in dotted lines). In the case of FIGS. 26-28, the cover serves as a support to the filter 40. In the case of FIG. 29, the cover also serves as a support for the fan 28 (here a transverse/tangential flow fan), which facilitates access to the fan, in particular for maintenance reasons.

Ideally the retracted positions of the filters in FIGS. 14 to 29 correspond to positions of non-use, whilst the emerged positions in these figures correspond to positions of use.

The device of the invention is capable of many variant embodiments.

As already indicated, it may have recourse to various types of fan, in particular of the radial type or transverse/tangential flow type.

Also, the nature of the filter is open to many variants. It may be a case for example of a particle filter, an activated carbon filter or a photocatalytic filter as already mentioned.

In a variant embodiment in FIG. 3, the curved-shaped partition 36 can be omitted, the air then being expelled by the turbine 26 in all directions, without being channeled.

The module of the invention can be located at a chosen position inside a cabin, in particular of an automobile. It will comprise for this purpose fixing means (not shown here) to enable it to be located in the cabin. Also electrical connection means are provided for electrically connecting the module to an electrical source, which may consist for example of a cigar lighter or any other electrical socket provided in the cabin.

What is claimed is:

1. An air ventilation module, in particular for a vehicle cabin, comprising a housing able to be installed in a chosen location in the cabin, the housing having at least one air inlet and at least one air outlet and accommodating an air propulsion member comprising at least one motor and a rotary element for moving the air, the rotary element being housing in a bottom chamber of the housing.

2. An air ventilation module as claimed in claim 1, comprising a filter.

3. An air ventilation module as claimed in claim 2, wherein the air propulsion member is placed upstream with respect to the filter, so that the internal chamber delimits an expansion volume for the compressed air issuing from the air propulsion member.

4. An air ventilation module as claimed in claim 3, wherein the expansion volume has a length along the air flow of between 0 mm and 10 mm.

5. An air ventilation module as claimed in claim 2, wherein the internal chamber is delimited at the discharge by the filter.

6. An air ventilation module as claimed in claim 2, wherein the air propulsion member is placed downstream with respect to the filter, so that the internal chamber delimits a volume for the filtered air.

7. An air ventilation module as claimed in claim 1, wherein the rotary element of the air propulsion member is a radial turbine.

8. An air ventilation module as claimed in claims 2, wherein the radial turbine is provided with blades and the filter is spaced apart from the turbine.

9. An air ventilation module as claimed in claim 1, wherein the rotary element of the air propulsion member is a tangential turbine.

10. An air ventilation module as claimed in claim 1, wherein the internal chamber delimits a fixed air volume.

11. An air ventilation module as claimed in claim 1, wherein the internal chamber delimits a variable air volume created by the mobility of at least one internal member of the module.

12. An air ventilation module as claimed in claim 2, wherein the filter is mounted so as to be able to move in the housing between a retracted position in which the volume of the internal chamber is reduced and an emerged position in which the volume of the internal chamber is increased.

13. An air ventilation module as claimed in claim 12, wherein the filter is mounted so as to pivot with respect to the housing.

14. An air ventilation module as claimed in claim 12, wherein the filter is mounted so as to move in translation with respect to the housing.

15. An air ventilation module as claimed in claim 1, comprising a cover closing the housing.

16. An air ventilation module as claimed in claim 15, wherein the cover has at least one air inlet and at least one air outlet.

17. An air ventilation module as claimed in claim 15, wherein the cover is mounted so as to be able to move with respect to the housing.

18. An air ventilation module as claimed in claim 17, wherein the filter is fixed to the cover.

19. An air ventilation module as claimed in claim 15, wherein the cover also supports the air propulsion member.

20. An air ventilation module as claimed in claim 2, comprising at least one filtered air outlet for the air issuing from the filter and at least one ventilated air outlet for non-filtered air and switching means for making the air pass selectively through the filtered air outlet and/or through the non-filtered air outlet.

21. An air ventilation module as claimed in claim 18, wherein the housing comprises a body provided with an open face and a cover mounted so as to pivot with respect to the body between a position retracted in the housing and a position emerged from the housing, the cover comprising at least one filtered air outlet provided in a main face and at least one non-filtered air outlet provided in a lateral face, the non-filtered air outlet being left clear by the housing body when the cover is in the emerged position and closed off by the housing body when the cover is in the retracted position.

22. An air ventilation module as claimed in claim 18, wherein the housing comprises a main face in which at least one air outlet is provided for filtered air and/or non-filtered air, and wherein the filter is mounted so as to slide opposite the air outlet, between a position in which the filter leaves clear the outlet in order to make non-filtered air pass and a position in which the filter closes off the air outlet in order to make filtered air pass.

23. An air ventilation module as claimed in claim 1, comprising at least one electrical element, in particular an element with a positive temperature coefficient for heating the air sent into the cabin.

24. An air ventilation module as claimed in claim 20, wherein the filter is chosen from amongst particle filters, activated carbon filters and photocatalytic filters.

25. An air ventilation module as claimed in claim 15, wherein the air inlet and the air outlet comprise elements for orienting the incoming and outgoing air flows of the housing.

26. An air ventilation module as claimed in claim 25 wherein the orientation of the incoming air flow through the air inlet is opposite to the orientation of the air flow emerging through the air outlets.

27. An air ventilation module as claimed in claim 1, wherein the housing comprises a so-called “functional” area grouping together the functional components of the module and a so-called “technical” area grouping together the components causing a degradation in the ventilation of the acoustic performance.
